(19) United States
(12) Patent Application Publication
(10) Pub. No.: US 2010/0264356 A1
(43) Pub. Date: Oct. 21, 2010

(54) MICROWAVE-HEATABLE THERMOPLASTICS HAVING A SELECTED HEATING RATE

(75) Inventors: Michael Cook, Horgen (CH); Robert P. Haley, JR., Midland, MI (US); Michael S. Paquette, Midland, MI (US)

Correspondence Address: The Dow Chemical Company;Osha Liang LLP, Two Houston Center, 909 Fannin Street, Suite 3500, Houston, TX, 77010-2002, US

(73) Assignee: DOW GLOBAL TECHNOLOGIES INC., Midland, MI (US)

(21) Appl. No.: 12/744,036

(22) PCT Filed: Nov. 17, 2008
(86) PCT No.: PCT/US08/83760

§ 371 Date: May 20, 2010

Related U.S. Application Data
(60) Provisional application No. 60/991,182, filed on Nov. 29, 2007.

(51) Int. Cl. C08K 3/34; C08L 23/12; H01B 1/20

(52) U.S. Cl. 252/62.54; 524/582; 524/450; 252/512; 252/518.1; 252/521.3; 252/511

(57) ABSTRACT

A method of formulating a microwave-heatable thermoplastic composition designed to have a selected heating rate. The method may include: selecting at least one of a microwave receptive additive, a microwave receptive additive particle size, and a concentration of the microwave receptive additive; selecting at least two inputs selected from the group consisting of a thermoplastic polymer composition, a microwave power, an electric field strength, a maximum allowable temperature of the thermoplastic polymer composition, a processing temperature of the thermoplastic polymer composition, and a thermal diffusivity of the thermoplastic polymer composition; and mixing a microwave receptive additive with a thermoplastic polymer to form the microwave-heatable thermoplastic composition having a selected heating rate based on the selecting at least one and the selecting at least two.

### BACKGROUND OF DISCLOSURE

1. Field of the Disclosure

Embodiments disclosed herein relate generally to microwave-heatable thermoplastic compositions. More specifically, embodiments disclosed herein relate generally to microwave-heatable thermoplastic compositions designed to have a selected heating rate.

2. Background

Thermoplastic polymer pellets typically must be melted, re-shaped and cooled in a primary conversion process, such as extrusion or injection molding, in order to make parts of commercial value. In some instances, a secondary fabrication process, such as thermoforming, which involves further heating, reshaping, and cooling is required to achieve parts of commercial value. In both primary and secondary processes, heat energy is applied to the thermoplastic and is subsequently removed after reshaping has occurred.

Conventional heating mechanisms for thermoplastic polymer systems in many instances rely on contact or radiant heat sources. Radiant energy, commonly referred to as infrared, has a wavelength in the range of 1 to 10 microns and will penetrate absorbing materials to a depth of approximately 1 to 2 microns before half of the available energy has been dissipated as heat. The process of heat transfer continues through a process of conduction (in the case of a solid material) or a combination of conduction, convection and mechanical mixing in the case of a molten material. Contact heating similarly relies on conduction (or a combination of conduction, convection, and mixing) from the hot contact surface to heat the “bulk” of the material.

The rate of heat transfer (RHT) associated with a conductive heat transfer process can generally be described by the relationship: RHT=f(A, Ct, Delta T), where A is the area available for heat transfer, Ct is the thermal diffusivity of the material, and Delta T is the available temperature driving force, which will decrease with time as the temperature of the material being heated increases. The thermal diffusivity, Ct, of unmodified thermoplastics is inherently low, thereby impeding the heat transfer in a conventional radiant or contact heating system. Furthermore, radiant or contact heating may result in an undesirable temperature gradient, potentially overheating or scorching the skin of the material being heated.

By way of contrast, microwaves have a wavelength of approximately 12.2 cm, large in comparison to the wavelength of infrared. Microwaves can penetrate to a much greater depth, typically several centimeters, into absorbing materials, as compared to infrared or radiant energy, before the available energy is dissipated as heat. In microwave-absorbing materials, the microwave energy is used to heat the material “volumetrically” as a consequence of the penetration of the microwaves through the material. However, if a material is not a good microwave absorber, it is essentially “transparent” to microwave energy.

Some potential problems associated with microwave heating include uneven heating and thermal runaway. Uneven heating, often due to the uneven distribution of microwave energy through the part, may be overcome to a certain extent, such as in a conventional domestic microwave oven, by utilizing a rotating platform to support the item being heated. Thermal runaway may be attributed to the combination of uneven heating outlined above and the changing dielectric loss factor as a function of temperature.

Microwave energy has been used, for example, to dry planar structures such as wet fabrics. Water is microwave sensitive and will evaporate if exposed to sufficient microwave energy for a sufficient period of time. However, the fabrics are typically transparent to microwaves, thereby resulting in the microwaves focusing on the water, which is essentially the only microwave-sensitive component in the material. Microwave energy has also been used to heat other materials, such as in the following references.

U.S. Pat. No. 5,519,196 discloses a polymer coating containing iron oxide, calcium carbonate, water, aluminum silicate, ethylene glycol, and mineral spirits, which is used as the inner layer in a food container. The coating layer can be heated by microwave energy, thereby causing the food in the container to brown or sear.

U.S. Pat. No. 5,070,223 discloses microwave sensitive materials and their use as a heat reservoir in toys. The microwave sensitive materials disclosed included ferrite and ferrite alloys, carbon, polyesters, aluminum, and metal salts. U.S. Pat. No. 5,338,611 discloses a strip of polymer containing carbon black used to bond thermoplastic substrates.

WO 2004048463A1 discloses polymeric compositions which can be rapidly heated under the influence of electromagnetic radiation, and related applications and processing methods.

A key limitation to the use of microwaves for heating polymeric materials is the low microwave receptivity of many useful polymers. The low microwave receptivity of the polymers thus requires either high powers or long irradiation times for heating such polymeric systems. In polymers designed specifically for microwave absorption, there is often a trade-off between their microwave properties and mechanical or thermal properties, i.e., the mechanical and thermal properties are often less than desirable.

Accordingly, there exists a need for processes and polymeric materials which facilitate the rapid, volumetric heating of the polymer using microwave energy.

### SUMMARY OF DISCLOSURE

In one aspect, embodiments disclosed herein relate to a method of formulating a microwave-heatable thermoplastic composition designed to have a selected heating rate. The method may include: selecting at least one of a microwave receptive additive, a microwave receptive additive particle size, and a concentration of the microwave receptive additive; selecting at least two inputs selected from the group consisting of a thermoplastic polymer composition, a microwave power, an electric field strength, a maximum allowable temperature of the thermoplastic polymer composition, a processing temperature of the thermoplastic polymer composition, and a thermal diffusivity of the thermoplastic polymer composition; and mixing a microwave receptive additive with a thermoplastic polymer to form the microwave-heatable thermoplastic composition having a selected heating rate based on the selecting at least one and the selecting at least two.

In another aspect, embodiments disclosed herein relate to a method of manufacturing a composition designed to have a selected heating rate, the method including: selecting at least two inputs selected from the group consisting of a thermoplastic polymer composition, a microwave power, an electric field strength, a maximum allowable temperature of the thermoplastic polymer composition, a processing temperature of the thermoplastic polymer composition, and a thermal diffusivity of the thermoplastic polymer composition; selecting at least one of a microwave receptive additive, a particle size of the microwave receptive additive, and a concentration of the microwave receptive additive; determining a heating rate of the microwave-heatable thermoplastic composition; and varying at least one of the microwave receptive additive, the particle size of the microwave receptive additive, and the concentration of the microwave receptive additive; and repeating the selecting, the determining a heating rate, and the varying until a selected heating rate convergence criteria is met.

In another aspect, embodiments disclosed herein relate to a method of manufacturing a multi-layered microwave-heatable thermoplastic composite designed to have a selected heating rate, the method including: selecting at least one of a microwave receptive additive, a microwave receptive additive particle size, and a concentration of the microwave receptive additive; selecting at least two inputs selected from the group consisting of a thermoplastic polymer composition, a microwave power, an electric field strength, a maximum allowable temperature of the thermoplastic polymer composition, a processing temperature of the thermoplastic polymer composition, and a thermal diffusivity of the thermoplastic polymer composition; mixing a microwave receptive additive with a thermoplastic polymer to form a microwave-heatable thermoplastic composition having a selected heating rate based on the selecting at least one and the selecting at least two; disposing the microwave-heatable thermoplastic composition having a selected heating rate as a layer in a multi-layered composite.

In another aspect, embodiments disclosed herein relate to a microwave-heatable thermoplastic composition designed to have a selected heating rate, including: a thermoplastic polymer composition; and a microwave receptive additive having a selected particle size and a selected concentration.

In another aspect, embodiments disclosed herein relate to a microwave-heatable multi-layered composite, including: at least one layer comprising a thermoplastic polymer composition; and a microwave receptive additive having a selected particle size and a selected concentration; wherein the microwave-heatable multi-layered composite has a selected overall heating rate

Other aspects and advantages will be apparent from the following description and the appended claims.

### BRIEF DESCRIPTION OF DRAWINGS

FIG. 1 illustrates a microwave heating device useful in embodiments described herein.

FIG. 2 illustrates one embodiment of a multi-layered sheet incorporating a microwave-heatable composition layer.

FIG. 3 is a graphical illustration of calculation results useful in manufacturing a microwave-heatable composition having a selected heating rate according to embodiments disclosed herein.

### DETAILED DESCRIPTION

Embodiments disclosed herein relate generally to microwave-heatable thermoplastic compositions. More specifically, embodiments disclosed herein relate generally to microwave-heatable thermoplastic compositions designed to have a selected heating rate.

Compared to alternative methods of heating, such as radiant, convective, or contact heating, the use of microwave energy may result in very rapid, volumetric heating. The use of microwave energy may overcome two fundamental limitations of the conventional heating systems: the dependence on the thermal conductivity of the polymer to transport heat energy form the surface of the part; and the maximum allowable temperature of the polymer surface which in turn determines the maximum available temperature driving force.

A polymer may inherently be receptive to microwaves based upon its chemical composition. Where a polymer is not inherently receptive to microwaves, a microwave-heatable polymer composition may be formed by combining the non-receptive polymer with a microwave receptive additive and/or a microwave receptive polymer. Suitable base polymers, microwave receptive polymers, and microwave receptive additives useful in embodiments of the present invention are described below.

The resulting microwave-heatable polymer compositions may be heated using microwave energy, in lieu of or in combination with radiant, convective, or contact heating. The heated polymer may then be mixed, transferred, shaped, stamped, injected, formed, molded, extruded or otherwise further processed, such as in a primary conversion process or a secondary fabrication process.

In other embodiments, the resulting microwave-heatable polymer compositions may be disposed as a layer in a multi-layered composite discrete layer (or several layers) in a multi-layered structure in such a way that the discrete layer (or layers) may be preferentially heated prior to subsequent fabrication. Heat energy may then be conducted from these layers to adjacent layers of polymer that may be essentially “transparent” to microwave energy, thereby allowing the total polymer structure to reach the required fabrication temperature more rapidly than with a conventional heating system. The multi-layered composite may then be mixed, transferred, shaped, stamped, injected, formed, molded, extruded or otherwise further processed, such as in a primary conversion process or a secondary fabrication process.

Embodiments disclosed herein relate to the efficient conversion of thermoplastic materials using electromagnetic energy, by selectively heating a portion of the volume of the thermoplastic material, that portion being sufficient to render the material processable in a subsequent forming technique. As used herein, processable means the provision of sufficient melt-state or softening of at least a portion of the thermoplastic in order for the bulk plastic to be mixed, transferred, shaped, stamped, injected, extruded, etc., to form a product. The heating of the thermoplastic substrate may be achieved by the exposure of the thermoplastic substrate to electromagnetic energy, such as microwaves, which have the ability to penetrate through the entire volume of the substrate and to be preferentially absorbed in microwave sensitive regions.

By applying microwave radiation, heat may be generated locally at a predetermined region of the volume, bulk, or part of the polymer specimen. Thus, the amount of energy applied may be carefully controlled and concentrated, as other regions may consist of non-absorbing materials which are transparent to the radiation used. For example, untreated polypropylene and polyethylene are transparent to microwave radiation. By heating portions of a substrate that are receptive to microwaves, the energy used to heat the entire composition may be reduced, the cycle times shortened and the mechanical and other properties of the final material may be adapted and optimized for various requirements and applications.

Sites within the microwave-heatable polymers and composites may be either favorable or non-favorable for absorption of the electromagnetic energy. Sites that are favorably absorptive will readily and rapidly heat under the influence of electromagnetic energy. In other words, only a specified portion of the volume of the substrate will be strongly affected by the electromagnetic energy, relative to other regions of the material.

In this manner, the electromagnetic energy interacts with only certain regions of the substrate, which will increase in temperature when electromagnetic energy is present. Heating of neighboring regions within the bulk material will subsequently occur due to thermal conduction and other such mechanisms. As the bulk material is heated volumetrically, the material may be converted into a processable state more rapidly as compared to conventional heating techniques. Moreover, because that material may contain less heat energy than would normally be present had the entire bulk material been heated via surface conduction (infrared heating), there may be considerable savings in energy. For example, infrared heating results in significant energy losses to the atmosphere, and requires that the surface temperature of the part is significantly higher than the desired bulk temperature in order to effect an acceptable rate of heat transfer from the part surface to the part core and raise the core temperature to that required for processing. In contrast, microwave selective heating, which causes the temperature of the microwave sensitive polymer to heat rapidly and volumetrically to the processing temperature, may result in a significantly lower polymer surface temperature, especially in such cases that comprise microwave transparent surface layers. Microwave heating may also have a lower tendency for energy to be lost from the system, transferring energy primarily to where it is needed, i.e. the microwave sensitive polymer. Microwave heating may also result in considerable savings in cycle time for a conversion process. The heating time may be reduced, not only because the microwave heating mechanism occurs rapidly throughout the bulk (in contrast to thermal conduction), but the total energy content of the part is less. The cooling cycle may also be reduced as the unheated regions of material effectively act as heat sinks to draw heat out of the neighboring heated regions, significantly enhancing the overall cooling rate of the bulk material.

The microwave-heatable polymers and composites described herein may be used during the primary conversion or secondary fabrication processes. For example, in some embodiments, the microwave-heatable polymers and composites may be used during the fabrication of polymeric articles including films, foams, profiles, compounded pellets, fibers, woven and non-woven fabrics, molded parts, composites, laminates, or other articles made from one or more polymeric materials. In other embodiments, the microwave-heatable polymers and composites may be used in conversion processes such as sheet extrusion, co-extrusion, foam extrusion, injection molding, foam molding, blow molding, injection stretch blow molding, and thermoforming, among others.

The above mentioned processes, such as thermoforming, injection molding, and others, have a cycle time associated with the process equal to the sum of the time attributable to each of the elements of the process (e.g., heating, injecting, forming, cooling, part ejection, etc.). Cycle times may include, for example, minimum cycle times, economically viable cycle times, maximum cycle times, and a cycle time range. Such cycle times are a characteristic of each process and are largely a function of the rate at which heat can be transferred into or out of the material. Such cycle times have a direct influence on economics, and other factors known to those skilled in the art.

Microwave-heatable compositions may incur uneven heating, such as due to uneven distribution of microwave energy during heating, and thermal runaways, such as due to a material having a changing dielectric loss factor as a function of temperature. Microwave-receptive additives, as mentioned above, may adversely affect the physical properties of the resulting polymer, and may therefore only be used in a limited capacity, thus limiting the impact of microwave energy on the bulk material. Multi-layered composites having one or more non-receptive layers may lessen the impact of a microwave-receptive additive on the physical properties, but may require additional time and microwave exposure to allow for heat conduction to the non-receptive portion to render the material processable. Uneven heating, thermal runaway, conduction, and physical property issues each affect the ability to heat via microwave energy and process the polymers in processes as described above, such as thermoforming and injection molding, among others.

To overcome the deficiencies associated with use of microwave-heatable compositions described above, microwave-heatable polymer compositions and composites described herein may be designed to have a selected heating rate. As used herein “heating rate” refers to the overall rate at which a microwave-heatable composition increases in temperature upon exposure to microwave energy. The temperature of a microwave-receptive particle may increase almost instantaneously, in some embodiments, upon exposure to microwaves. In contrast, the heating rate of the microwave-heatable composition is the rate at which the bulk composition increases in temperature. Selected heating rates may allow for microwave-heatable polymers and composites to meet cycle time requirements, physical property requirements, and other limitations imposed to meet various process requirements, such as melt viscosity, resulting part thickness, draw-down ratios, cooling rates, and formability, among others.

As an example of designing a composition to have a selected heating rate, one may approximate a composition as including a microwave receptive particle that is spherical and uniform in shape. One may also assume a uniform dispersion of these spherical particles in the non-receptive polymeric matrix, which may be considered as a simple cubic lattice. The size “a” (length, width, and height) of the cubic lattice cannot be smaller than twice the radius of the particle, rₚ; otherwise the particle would not fit in the lattice (i.e., a≧2rₚ). Thus, the minimum volume fraction of a spherical particle centered in the lattice cube is zero, and the maximum volume fraction of a sphere centered in a cube, as a percentage, is approximately 52.36% (f=pi/6). The rate at which a microwave receptive additive heats to a temperature in a given electric field is fast relative to the heat transfer from the microwave receptive additive to the bulk polymer matrix. Thus, the microwave receptive additive particle temperature may be regarded as a function of only electric field strength (microwave power). With these assumptions, the rate of heat transfer from the microwave receptive additive particle to the polymer matrix within a lattice may be calculated. For example, the temperature of the microwave receptive additive may be considered a fixed boundary condition, and the lattice boundaries have an initial condition of room temperature or feed temperature to the microwave heating unit. The dynamic heat transfer from the fixed boundary condition to the polymer matrix surrounding the microwave receptive additive may then be calculated based on the thermal diffusivity of the polymer. The time it takes the lattice boundary to reach a given temperature may then be regarded as the heating rate. Adjacent lattices should heat at a similar rate, based on the assumptions made, and the heated area may be considered at equilibrium, although a minor temperature variance may exist across the lattice.

### Example

As an example of designing a composition to have a selected heating rate, results from heating rate calculations as described above, which may be used to manufacture a microwave-heatable composition having a selected heating rate according to embodiments disclosed herein, are shown in FIG. 3. The microwave receptive particle size, rₚ, was varied from 5 nm to 65 microns. The lattice size, a, was varied based on the particle size, where the particle/polymer volume fraction was varied from nearly zero to 52% (particle diameter approximately equal to lattice size, a). The heating rate envelope is bounded where the particle size diameter, rₚ, equals the lattice size, a. For the calculation results presented, the particle temperature was set at 165° C., slightly above the melting temperature of the non-receptive polymer matrix, polypropylene. Although not necessary for calculation, such a particle temperature may result based upon the selection of an appropriate microwave receptive additive and electric field strength.

The calculated heating rate presented in FIG. 3 is based upon the amount of time calculated for the corners of the cubic lattice to reach “equilibrium” at 164.9 degrees. As illustrated, heating rates may range from very slow, such as where the particle size is small compared to the lattice size, to very fast, such as where a particle size is approximately equivalent to the lattice size. As shown, the resulting heating rates of the polymer range from tens of degrees per minute to 1×10⁶ degrees per minute.

Selected heating rates, such as to meet cycle time and/or physical property requirements for a given polymer system, may lie within the triangle shown in FIG. 3, for example. The highest heating rates are limited by the constraint that the bulk polymer must remain in tact. This upper limit is polymer dependent. The lower limit is set by the economics of the thermoforming process. Such upper and lower limits for particle size, heating rates, etc. and the bounds thereof (such as lying within the triangle for the system of FIG. 3) may be referred to as the performance envelope.

One of the assumptions used to obtain the results shown in FIG. 3 is the microwave receptive additive particle temperature. The location of the heating envelope may depend on numerous factors, including the microwave receptive additive chosen and the strength of the electric field to which the microwave receptive additive is exposed. For example, a stronger electric field may result in a higher particle temperature for a given microwave receptive additive. Alternatively, various microwave receptive additives may result in higher or lower particle temperature from similar electric field strengths. Numerous other variables may also affect the location of the heating rate envelopes for a given system. Thus, although not illustrated, one skilled in the art would appreciate that a three dimensional graph may be generated based on the calculations above for any given polymer-microwave receptive additive system, as described above, where the third axis may represent electric field strength or polymer thermal conductivity, for example. Such charts could be a useful tool when designing a microwave-heatable composite to have a selected heating rate according to embodiments disclosed herein. The surfaces of the resulting chart (for the bounds of the heating rate envelope or for individual particle size “ribs”) may be defined mathematically, where the resulting heating rate or heating rate envelope equations may additionally provide a tool for designing a composite to have a selected heating rate.

Design of a composite to have a selected heating rate, as described briefly above, must account for the numerous variables within the system. For example, variables that may affect the heating rate of a composition may include, among others, the type, particle size, and concentration of the microwave receptive additive, the thermoplastic polymer composition, the strength of the electric field used to heat the composition, and the thermal diffusivity of the thermoplastic polymer composition.

Designing a composition to have a selected heating rate may begin by providing as input to a calculation loop one or more of the above listed variables, as appropriate. The heating rate for the composition may then be calculated. If the heating rate calculated for a given polymer—microwave receptive additive combination is not within a variance or convergence criteria from the selected heating rate, the variables mentioned above may be varied, and the heating rate re-calculated until a selected heating rate convergence criteria is met. For example, for a given polymer system and electric field strength, one may vary at least one of the microwave receptive additive, the particle size of the microwave receptive additive, and the concentration of the microwave receptive additive until the selected heating rate convergence criteria is met.

Based on the calculations above, a microwave-heatable thermoplastic composition designed to have a selected heating rate may be manufactured. For example, a microwave-heatable composition may be formed by mixing the thermoplastic composition and the microwave receptive additive based on a result of the above-described calculation loop.

Other variables may also impact the desire to manufacture a microwave-heatable composition based on the above-described calculation loop. For example, selected heating rate convergence criteria may be met where the microwave receptive additive has an excessively large particle size and concentration, which may result in unacceptable physical properties of the resulting microwave-heatable composition. Accordingly, the above calculation loop may also include various constraints, limiting the maximum and/or minimum values for such variables as microwave receptive additive particle size, concentration, electric field strength, and others. Similarly, constraints may be used to limit the selections so as to not exceed a maximum temperature of a thermoplastic composition. Appropriate constraints may also be put on processing temperatures. For example, processing temperatures may be less than a polymer melting temperature in some embodiments, such as for thermoforming, and may be greater than melting temperature in other embodiments such as for injection molding. One skilled in the art will recognize that the potential constraints discussed above are non-limiting and that other constraints may also be used.

In one embodiment, the above calculation loop may be performed on a computer. Appropriate variable inputs may be used, requiring a user interface. Additionally, a result of the calculations may be graphically displayed, such that one may review the results.

In some embodiments, calculations performed may additionally include design considerations for use of a microwave-heatable composition having a selected heating rate in a multi-layered composite. For example, calculations may be included to estimate the heat transfer from a layer including a microwave-heatable composition to a non-heatable layer. The heating rate required to make a bulk composite processable may thus be estimated, and in turn, the heating rate for the one or more microwave-heatable layers may be appropriately selected.

Microwave-heatable polymers and composites described herein, designed to have a selected heating rate, may be formed, in some embodiments, by a) selecting at least one of a microwave receptive additive, a microwave receptive additive particle size, and a concentration of the microwave receptive additive; and b) selecting at least two inputs selected from the group consisting of a thermoplastic polymer composition, an electric field strength, a maximum allowable temperature of the thermoplastic polymer composition, a processing temperature of the thermoplastic polymer composition, and a thermal diffusivity of the thermoplastic polymer composition. Based on a) and b), a microwave receptive additive may be mixed with a thermoplastic polymer to form the microwave-heatable thermoplastic composition designed to have a selected heating rate.

Regarding the microwave receptive additive, numerous microwave receptive additives may be used in various embodiments disclosed herein (see section captioned “Microwave Receptive Additive”). Properties of these additives may be used and/or adjusted in conjunction with variables b) to effect a microwave-heatable composition having a selected heating rate.

For example, microwave receptive additives may respond to different microwave frequencies. This may, of course, be dependent upon the dielectric loss characteristics, electric permittivity, and/or the magnetic permeability of a selected additive or receptive moiety. While one microwave receptive additive may be heated at a frequency of 2450 MHz, for example, other receptive additives may respond to a different frequency within the range from 1 MHz to 300 GHz.

Upon exposure to microwaves, the temperature of the microwave receptive portion of the composition may be influenced by the strength of the applied electric field. For example, for a given electric field strength, a first microwave receptive additive may increase rapidly to a temperature of 160° C., whereas a second microwave receptive additive may increase to a temperature of 220° C. A stronger electric field may result in the first microwave receptive additive increasing rapidly to a temperature of 180° C. or higher.

These microwave receptive additives may come in a variety of shapes and sizes, and may be used at a concentration ranging from 0 to 25 volume percent or more of the microwave-heatable composition. The size of the receptive particle, in combination with the concentration of the particles in a polymeric matrix, may influence the heating rate of the composition. For example, for equivalent sized particles of the same receptive additive, use of the additive at a higher concentration results in less non-receptive thermoplastic polymer that needs to be heated per particle. Thus, when a microwave receptive additive is used at higher concentrations, a microwave-heatable composition may have a faster heating rate.

In addition to particle size, particle size distribution is a variable of interest. For example, additives having an equivalent average particle size may have varying particle size distributions, where a first additive may have a greater number of smaller and/or larger particles than a second additive. This, as with particle size alone, may affect the amount of non-receptive thermoplastic polymer that needs to be heated per particle, on an average basis. Additionally, the distribution of heat energy that results due to varying particle size distributions may affect the overall heating of the composition when exposed to microwave energy. In general, narrow particle size distributions may result in the even distribution of heat energy; however, narrow particle size distributions may not be a preferred option due to cost or the possible influence on physical properties of the resulting composition. In other words, for some embodiments disclosed herein, a narrow particle size distribution may be preferred; in other embodiments, a broad particle size distribution may be preferred.

The microwave additive compositions may also play an important role in the ability to tailor a composition to a selected heating rate. For example, zeolites may be receptive to microwave energy. Zeolites may also absorb water, which is also receptive to microwave energy. Thus, a zeolite with absorbed water may result in a different heating rate than a dry zeolite. Zeolites having different amounts of absorbed water may also result in different heating rates.

The overall heating rates of a microwave-heatable composition may also be influenced by the thermal diffusivity of the non-receptive thermoplastic used in the composition. Polymers having a greater thermal diffusivity may disseminate heat from a microwave receptive additive to the bulk composition at a faster rate than polymers having a lower thermal diffusivity.

The above factors, including electric field strength, polymer thermal diffusivity, as well as microwave receptive additive, particle size, particle size distribution, and concentration, may influence the rate at which the bulk microwave-heatable compositions may be heated. Selected heating rates for use of a microwave-heatable composition in a particular process may also depend upon such factors as the processing temperature of the microwave-heatable composition, a melting temperature of the thermoplastic polymer composition, and a maximum temperature of the thermoplastic polymer composition.

With respect to processing or melting temperature, polymers having a higher processing temperature, for example, may require longer heating times or higher heating rates as compared to polymers having a lower processing temperature. With respect to the maximum temperature for a thermoplastic composition, certain polymers may begin to degrade or depolymerize above a given temperature. Additionally, lower molecular weight polymers, waxes, residual monomer, or other additives used in a polymer system may volatilize above a given temperature, each of which may result in changes in physical properties or appearance of the resulting product. For example, polymers which degrade may lose physical strength (impact, Dart, tensile or flexural strength, etc.); volatilization of components may result in the formation of bubbles or gaps in a part. Thus, the processing temperature and/or maximum temperature for a thermoplastic composition may influence the choice of microwave receptive additive and the strength of the electric field used to heat the microwave-heatable thermoplastic compositions disclosed herein.

As shown by the brief discussion above, these and other variables may influence the heating rate of a composition. The heating rate selected for a composition may depend upon these factors, among others. The selected heating rate of a composition may be selected to increase the temperature of the composition to a temperature equal to or greater than the processing temperature of the composition for a desired cycle time, for example. In other embodiments, the heating rate of the composition may be selected to meet a cycle time range. Selected heating rates, as mentioned above, may allow for microwave-heatable polymers and composites to meet cycle time requirements, physical property requirements, and other limitations imposed to meet various process requirements, such as melt viscosity, resulting part thickness, draw-down ratios, cooling rates, and formability, among others.

As shown above, a number of variables may be used to design and manufacture a microwave-heatable composition or multi-layered composite that has a selected heating rate. Microwave-heatable compositions and composites designed to have a selected heating rate, as described herein, may include microwave-receptive additives, microwave-receptive polymers, and non-receptive polymers (base polymers). Each of these is discussed below.

Microwave Receptive Additive

A number of materials may be heated by the absorption of microwaves. This may be achieved by a dipolar heating mechanism and involves the stimulated movement of permanent dipoles and/or charges, as they attempt to oscillate in sympathy with the oscillating electromagnetic wave moving through the material. The material is thus heated by agitation of molecules and the subsequent viscous transfer of heat to neighboring atoms and molecules. Other materials may heat through Ohmic (resistance) heating as the electric field of the electromagnetic wave stimulates current flow within the material. Yet other microwave heating mechanisms include Maxwell-Wagner and magnetic heating mechanisms. The degree to which any material will heat in the presence of a microwave field is defined by its dielectric loss factor (also referred to as loss tangent or complex dielectric permittivity), which is in effect a measure of the strength of interaction between the material and the electromagnetic wave. Crucially, this heating is a bulk effect, that is, the material effectively heats “volumetrically” and a desired temperature distribution may therefore be achieved in a part through appropriate part design. For example, in a coextruded sheet designed for thermoforming, a microwave sensitive core layer enables the sheet to be heated from the inside out resulting in a cooler, more desirable sheet surface temperature.

Microwave absorbing agents may also be used as an additive in a material to render the material heatable by electromagnetic radiation (usually microwave or radar). Other agents added to polymeric materials, to change or improve certain properties, may also impart improved heatability to the polymer. Such additives can be added to polymers to facilitate microwave heating of the polymers.

The microwave receptor, or the additive which may be blended with a base thermoplastic polymer to form a microwave sensitive polymer, may include conductive or magnetic materials such as metals, metal salts, metal oxides, zeolites, carbon, hydrated minerals, hydrated salts of metal compounds, polymeric receptive materials, clays, organo-modified clays, silicates, ceramics, sulfides, titanates, carbides, and sulfur, among others. Microwave receptive additives may include:
a) elements, such as C, Co, Ni, Fe, Zn, Al, Cu, Ag, Au, Cr, Mo, and W;
b) heavy metal salts, such as CuXₙ, ZnX₂, or SnX₂, where X is a halogen, and n is an integer from 1 to 6;
c) salt hydrates, such as NiCl₂.6H₂O, Al₂(SO₄)₃.18 H₂O;
d) complex hydrates, such as ettringite;
e) other simple hydrates, such as Epsom salts;
f) metal oxides, such as CuO, Cu₂O, NiO, Fe₃O₄, Fe₂O₃, FeO CO₂O₃;
g) complex oxides, such as BaTiO₃;
h) metal sulfides, such as Ag₂S, CuS, MoS₂, PbS, ZnS, FeS iron pyrite (FeS₂), and other pyrites;
i) metal carbides and nitrides, such as W₂C, SiC, B₄C, and TiN;
j) semiconductors such as Si, Ge, Se, GaP, GaAs, InP, InAs, CdS, CdSe, and ZnSe;
k) ion conductors, such as solid acids, beta alumina, polymer acids, and ion exchangers;
l) water-containing materials, such as hydrated forms of zeolites, silicas, aluminas, aluminophosphates, aluminosilicates, magnesia, titania, clays, micas, gels, vermiculites, attapulgites, sepiolites, other inorganic gels, organic hydrogels such as superabsorbant polymers (SAP), Methocel, and hydroxyethylcellulose (HEC), carboxymethylcellulose, and microencapsulated water;
m) molecular, oligomeric, or polymeric material with permanent dipoles, such as molecules, oligomers, or polymeric materials having functionalities which may include mono- or poly-substitution with hydroxyls, amines, amides, carbonyls, esters, carbonates, carbamates, ureas, thioureas, nitriles, nitros, nitrates, nitrosyls, hydroxylamines, ammoniums, sulfonamides, sulfhydryls, sulfides, sulfones, sulfoxides, phosphates, phosphonates, phosphonamides, halides, oxyhalides, and may also include sugars, amino acids, lactams, ethylene carbon monoxide (ECO) copolymers, polyamides, polyesters, polyacrylates, acrylate copolymers, acrylate-modified polymers, starches, keratin, gelatin, other bioproducts, formamide, n-methyl formamide, n-methylacetamide, and combinations thereof;
n) caged dipoles, such as the dipoles listed in (m) above absorbed in zeolites or clays or on silica gel or other inorganic or organic sorbants, or encapsulated;
o) organic conductors, other than metals and semiconductors, such as polyaniline, polypyrrole, polyacetylene, and other organic conductors;
p) magnetics, such as hard or soft ferrites, Sr or Ba titanates, CoZn, NiZn, or MnZn.

In some embodiments, the microwave receptive additive may include, for example, copper, aluminum, zinc oxide, germanium oxide, iron oxide or ferrites, alloys of manganese, aluminum and copper, manganese oxide, oxides of cobalt or aluminum, SiC, Na₂TiO₃, Al₂O₃, MnO₂, TIO₂, and Mg₂TiO₄. In other embodiments, microwave receptive carbon may include, for example, graphite, carbon black, graphene, and carbon nanotubes. In particular embodiments, the microwave receptive additive may include aluminum silicates, iron ferrites such as Fe₃O₄, zeolites such as Zeolite A, carbon, or combinations thereof.

In addition to the above microwave receptive additives, it has been discovered that certain other crystalline additives may be effective as microwave receptors, and may include ionic conductors such as inorganic solid acids or salts, polymer acids or salts, or inorganic or polymeric ion-exchangers. In one particular embodiment, an ion-exchanging additive is the synthetic Zeolite 4A.

Other compounds that may be effective as microwave receptors include water containing materials where the additive contains an amount of water which enhances the receptivity. This hydrated additive may be based on inorganic, molecular, or polymeric substances. For example, a hydrated inorganic additive may be a hydrated Zeolite 13X, where the zeolite is capable of absorbing up to 30% of its weight as water.

Other compounds that may be effective as microwave receptors include inorganic or polymeric substances which contain a molecular or polymer microwave receptor. The receptor species may lay within the inorganic or polymeric substance, may be present as a coating on particles of the inorganic or polymeric substance, or may be a guest within pores of the inorganic or polymeric substance. For example, ethylene glycol may be adsorbed in the 3-dimensional cages of zeolite NaY.

Sepiolite clay may also be used as a microwave receptive additive. Sepiolite is a natural clay mineral that contains strongly held water. The strongly held water may allow for microwave receptivity of the clay, and may also provide for heating with essentially no bubble formation or minimal bubble formation due to the presence of the water during heating.

Molecular sieves or zeolites formed from an ammonium ion salt or a hydrogen ion salt may also be used as a microwave receptive additive. For example, an ammonium form of molecular sieve Y may be used.

Zeolite-like synthetic materials may also be used as a microwave receptive additive. For example, synthetic materials such as aluminophosphates, silicoaluminophosphates, and silicotitanates, and other admixtures of light metals having structures and hydration behavior similar to that of zeolitic materials, may be used.

In other embodiments, molecular sieves described above, including zeolites formed from alkali metal salts, alkaline earth metal salts, ammonium ion salts, and hydrogen ion salts, may include an adsorbed organic material in the zeolite cages. For example, ethylene glycol and other microwave receptive organic materials may be adsorbed in the zeolite or molecular sieve, providing enhanced microwave receptivity to the molecular sieve.

Still other compounds that may be effective as microwave receptors include materials which may impart receptivity and selective heating to the desired portion of the part. These may include organic conductors such as polyaniline.

In addition to the above additives, microwave receptive polymeric materials may be used as the major component of a microwave sensitive layer, or may be a minor component blended with other low- or non-microwave receptive polymers to form a microwave sensitive layer. Polymeric receptive materials may include ethylenevinylalcohol polymers, polyketones, polyurethanes, polyamides, polyvinylchloride, polyacrylates, ethylene carbon monoxide copolymers, polyaniline, and others, for example. Microwave receptive polymers may be formed where certain groups are incorporated into the polymer structure, such as CO, OH, NH, methacrylates, carbon dioxide, acrylic acids, vinyl acetate, alcohols, and vinyl or polyvinyl alcohols, for example. Such microwave receptive moieties may be incorporated into the backbone of the polymer chain or may be appended to the polymer chain.

As described above, microwave-receptive additives may contain tightly bound water, such as zeolites and clays. These materials may also include adsorbed water which may be released from the additive upon heating. In some embodiments, microwave-receptive additives may be dried before combination with the polymer. In some embodiments, microwave-receptive additives may be combined with a polymer and the water removed, such as through use of a vented extrusion system. In other embodiments, parts or sheets of polymer containing microwave-receptive additives with bound water may be dried prior to processing of the sheet in a microwave apparatus. In this manner, undesired bubble formation due to excess water may be minimized or avoided.

In some embodiments, the microwave receptive additive may be in the form of powders, flakes, spheres, pellets, granules, liquids, or gels. The preferred form of the microwave receptive additive may depend on the stage at which the additive is blended, such as during the polymerization process, during purification or pelletizing of the polymer, or during a compounding process. In other embodiments, the additive may be compounded immediately prior to or during a primary conversion or secondary fabrication process, such as during extrusion, injection molding, or other processes using polymers. In some embodiments, the blending of a microwave receptive additive may impart improved microwave receptivity without significant effect on the properties of the polymer matrix.

Any of the above additives may be used separately or in combination to provide the desired effect of selective heating. For example, a synergistic effect may be realized where various zeolites are combined, giving much higher receptivity than one form of zeolite alone, and where only a solid (i.e. hydrated zeolite) is added to the formulation. The additive, such as in this example, may remain as a solid powder, which may be compounded into the polymer without difficulty. The size of the microwave receptive additive used may depend upon the size of the polymer matrix in which the additive is to be dispersed; thicker matrices may accommodate larger particles. In some embodiments, the average particle size of the microwave receptive additive may range from 10 nm to 50 microns; from 100 nm to 40 microns in some embodiments; from 0.1 microns to 25 microns in other embodiments; from 1 micron to 15 microns in other embodiments; and from 5 microns to 10 microns in yet other embodiments. Particles sizes used may include monodisperse particles (having a narrow size range), or polydispers particles (having a broad size range)

In some embodiments, microwave receptive additives may exhibit a narrow band response to electromagnetic energy. In other embodiments, the microwave receptive additive may be heated by irradiation across a broad band of frequencies. In one embodiment, the additive may be regarded as having a receptive nature over a frequency range from 1 MHz to 300 GHz or above. In other embodiments, the additive may be heated in a frequency range from 0.1 to 30 GHz or above; from 400 MHz to 3 GHz in other embodiments; and from 1 MHz to 13 GHz or above in other embodiments. In yet other embodiments, the additive may be heated in a frequency range from 1 to 5 GHz.

In some embodiments, a microwave sensitive polymer may be formed by dry blending a base polymer and a microwave receptive additive. In other embodiments, a microwave sensitive polymer may be formed by compounding or by coating the additive with the polymeric material. In yet other embodiments, a microwave sensitive polymer may be formed by blending a microwave receptive additive with a wet polymer dispersion and subsequently drying off the water from the dispersion.

Base Polymer

Polymers which may be combined with one or more microwave receptive additives to form a microwave-heatable composition include resins selected from polyolefins, polyamides, polycarbonates, polyesters, polylactic acid and polylactide polymers, polysulfones, polylactones, polyacetals, acrylonitrile-butadiene-styrene resins (ABS), polyphenyleneoxide (PPO), polyphenylene sulfide (PPS), styrene-acrylonitrile resins (SAN), polyimides, styrene maleic anhydride (SMA), aromatic polyketones (PEEK, PEK, and PEKK), ethylene vinyl alcohol copolymer, and copolymers or mixtures thereof. In certain embodiments, polyolefins and other polymers which may be combined with a microwave receptive additive include polyethylene, polypropylene, polystyrene, ethylene copolymers, propylene copolymers, styrene copolymers, and mixtures thereof. In other embodiments, polymers which may be combined with a microwave receptor include acrylonitrile-based polymers, hydroxyl group-containing polymers, acryl- or acrylate-based polymers, maleic anhydride-containing or maleic anhydride-modified polymers, acetate-based polymers, polyether-based polymers, polyketone-based polymers, polyamide-based polymers, and polyurethane-based polymers.

Microwave-Heatable Compositions

In certain embodiments, the microwave-heatable composition may be formed by combining from 0.1 to 200 parts by weight microwave receptive additive per hundred parts base polymer. In other embodiments, the microwave sensitive polymer may be formed by combining from 1 to 100 parts by weight microwave receptive additive per hundred parts base polymer; from 2 to 50 parts in yet other embodiments; and from 3 to 30 parts in yet other embodiments.

In certain embodiments, the content of the microwave receptive additive may comprise from 0.1 to 25 volume percent of the microwave sensitive polymer. In other embodiments, the content of the microwave receptive additive may comprise from 1 to 20 volume percent of the microwave-heatable polymer composition; and from 2 to 15 volume percent in yet other embodiments.

In some embodiments, the microwave-heatable polymer composition may be in the form of powder, granules, pellets, uneven chippings, liquid, sheets, or gel. The microwave-heatable polymer composition may be crystalline, semi-crystalline, or amorphous. In some embodiments, the microwave-heatable polymer composition may include colorants, reinforcing or extending fillers, and other functional additives such as flame retardants or nanocomposites.

The microwave-heatable polymer compositions and multi-layered composites described herein may have a selected heating rate of at least 5° C. per second in some embodiments; at least 10° C. per second in other embodiments; at least 20° C. per second in other embodiments; at least 30° C. per second in other embodiments; at least 50° C. per second in other embodiments; up to 100° C. per second in other embodiments; up to 120° C. per second in other embodiments; and up to 150° C. per second in yet other embodiments.

Uniform heating of the microwave-heatable polymer compositions and multi-layered composites described herein may result when the same are exposed to microwave energy. Uniform heating, as used herein, refers to the heating of a composition, composite, part, sheet, or at least a selected portion of a sheet, wherein the heated portion has a maximum temperature variance of 10° C. or less in some embodiments. In other embodiments, the microwave heating may result in a temperature variance of 7.5° C. or less in other embodiments; 5° C. or less in other embodiments; 4° C. or less in other embodiments; and 3° C. or less in yet other embodiments. Such temperature variances described above may include each of the width, depth, and thickness of a sheet, for example.

Microwave Heating Apparatus

Microwave-heatable compositions and composites, designed to have a selected heating rate as described above, may be heated using a microwave heating apparatus for further processing. Such apparatus are described in, for example, PCT Application No. PCT/US2007/012821, which is hereby incorporated by reference in its entirety.

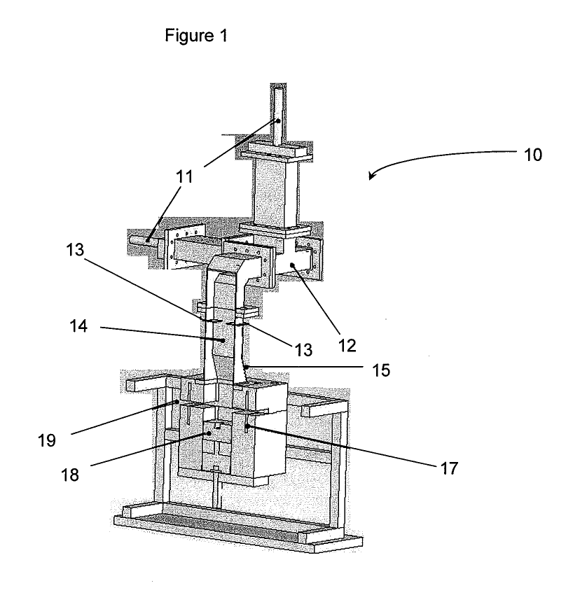

Referring now to FIG. 1, a microwave heating apparatus 10 that may be used in accordance with embodiments of the microwave sensitive polymers disclosed herein is illustrated. Components of microwave heating apparatus 10 include tuning pistons 11, EH tuner 12, matching iris plates 13, waveguide 14, horn 15, microwave choke 17 and lower moveable piston 18. Polymer sheets may be processed through the microwave heating apparatus 10 by feeding the samples through the sample feed slot 19.

In some embodiments, microwave heating apparatus 10 may be capable of rapid and uniform heating of microwave-heatable compositions, and may adapt to the nature of the microwave-heatable composition (receptor type, receptor concentration, thermoplastic matrix type, etc.) and the form of the material being processed (thickness, shape, etc.). By comparison to conventional infrared heating, the heating rates and temperature variances afforded by various embodiments of the microwave heating apparatuses disclosed herein may provide an advantage in cycle times, may minimize the deleterious effects on the polymer due to excess heat exposure, as well as provide improved processing.

Apparatus 10 may include a variable power source (not shown); horn 15 may provide a uniform energy density spread; and iris plates 13 and EH tuner 12 may allow for fine tuning of the wavelength emitted. In this manner, the microwave emitter may be tailored to efficiently heat a particular microwave-heatable composition. Analytical measurement devices (not shown) may also be provided to monitor the temperature of the material being processed, among other variables. Although described with respect to heating sheet, other microwave heating apparatuses and processes may also be used with the microwave-heatable compositions and composites described herein.

The power rating for the microwave emitter employed may depend on the composition, size or thickness of the polymer specimen being heated, and the desired temperature. The power rating may also be selected based on variables such as the maximum allowable polymer temperature, and based on the cycle time for operations occurring upstream or downstream from the heating stage. In certain embodiments, a variable power source may be employed, providing process flexibility, such as the ability to vary a part size or composition (amount or type of microwave receptive additive).

Applications

As described above, the microwave-heatable compositions and composites designed to have a selected heating rate disclosed herein may be heated for subsequent processing, such as being mixed, transferred, shaped, stamped, injected, formed, molded, extruded, or otherwise further processed. In some embodiments, the microwave-heatable compositions and composites having a selected heating rate may be useful in thick sheet thermoforming processes, such as for forming refrigerator liners, for example. In other embodiments, microwave-heatable compositions and composites designed to have a selected heating rate disclosed herein may be useful for the processing of air laid binder fibers, for example. In other embodiments, microwave-heatable compositions and composites designed to have a selected heating rate disclosed herein may be useful in blow molding processes, such as for the formation of blown bottles, for example. In other embodiments, microwave-heatable compositions and composites designed to have a selected heating rate disclosed herein may be useful in foams, extruded foams, and other structures containing foam or a foam layer.

In other embodiments, microwave-heatable compositions and composites designed to have a selected heating rate disclosed herein may be useful in applications where the polymer being processed is not completely molten. For example, microwave-heatable compositions and composites designed to have a selected heating rate may be selectively heated, heating a only select portion of the polymer passing through the apparatus, thereby concentrating the heat energy to only that portion being further processed, such as by a forming, molding, or stamping process. This may enhance the structural integrity of the material handled during processing, may reduce cycle times, and may reduce the energy required for processing the material into the desired shape.

In other embodiments, microwave-heatable compositions and composites designed to have a selected heating rate disclosed herein may be useful in embossed sheets. In conventional infrared thermoforming, heat input must pass through the surface of the sheet, and often reduces the retention of the embossing structure or surface details. In addition to the reduced heating cycles, as described above, microwave-heatable compositions and composites designed to have a selected heating rate may allow for increased retention of embossing structures during processing due to the reduced energy footprint imparted to the sheet.

As mentioned above, composites may be formed including microwave-heatable layers interspersed with non-microwave-heatable layers. Such composites may provide for: optimum temperature profiling; the use of pulsed microwave energy during processing of the composite; the selective placement of the microwave emitters providing for heating of specific regions of a part; and other manifestations which may provide for preferential or selective heating by virtue of the microwave sensitivity of the one or more microwave-heatable layers.

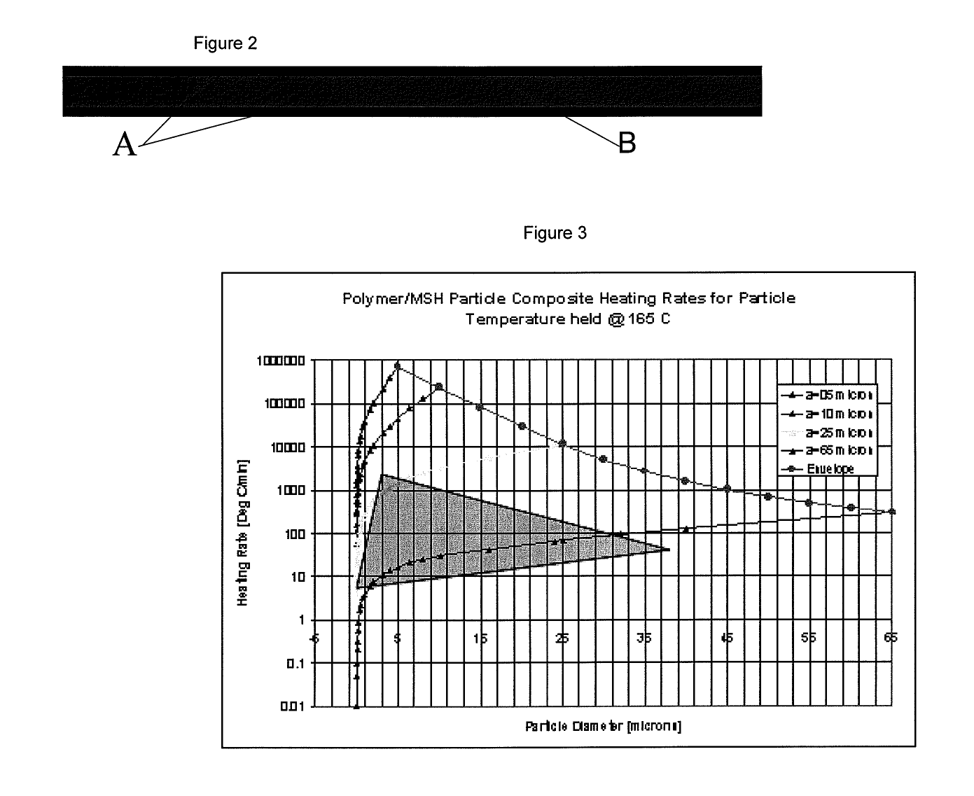

As one example of sheet extrusion, a microwave sensitive layer may be incorporated into a multilayered sheet. For example, FIG. 2 illustrates one embodiment of a multilayered sheet incorporating a microwave sensitive layer. The microwave sensitive layer B may form a sheet core, bounded by outer layers A not sensitive to microwave heating. Incorporation of a microwave sensitive core layer may facilitate subsequent processing of the sheet, such as during sheet thermoforming. In some embodiments, sheet thermoforming may be facilitated by use of a microwave selective polymer by enabling thick sheet thermoforming, selective drawability, and rapid, uniform heating of the sheet.

Layered sheets as disclosed herein may include 2 or more layers, where one or more layers may include or be formed from microwave-heatable compositions and composites designed to have a selected heating rate. For example, layered sheets may include 3, 4, 5, 6 . . . up to 1000 layers or more. In some embodiments, individual layers may have an average thickness of 0.1 microns to 25 mm, and the total thickness of the sheet may range from 100 microns to 25 mm. In some embodiments, sheets may include microlayered sheets, having multiple micron-thick layers.

Although illustrated in FIG. 2 as a three layered sheet, in other embodiments microwave-heatable compositions and composites designed to have a selected heating rate may form a region or regions within a polymer structure. For example, a microwave-heatable composition may form a discrete layer in a sheet having two or more layers. In other embodiments, the microwave-heatable composition may form specific regions of a larger structure, allowing selective heating of those regions for further processing. In yet other embodiments, the microwave-heatable composition may form one side of a side-by-side fiber structure. In yet other embodiments, the microwave-heatable composition may form the core or the sheath of a core/sheath fiber structure.

In a foam extrusion process, for example, incorporation of a microwave-heatable composition may allow selective heating of the foam core and the solid, non-receptive skin, enabling shorter heating cycles while preventing collapse of the foam structure. In other embodiments, incorporation of different concentrations of the microwave receptive additive in each of the microwave-heatable composition layers may allow differential heating of each of the layers and hence optimization of any subsequent fabrication step, such as thermoforming. In other embodiments, incorporation of a microwave-heatable composition layer may allow selective foaming of a post-formed sheet.

In other embodiments such as injection molding or injection stretch blow molding, incorporation of a microwave-heatable composition layer may allow shorter cycles due to the internal cooling of the polymer, where the non-receptive portions of the part act as heat sinks and therefore provide a reduced cooling time. Injection molding may also be facilitated by use of pulsed microwave energy, resulting in a mixture of molten and semi-molten material which can be injection molded, the semi-molten material acting as a heat sink during subsequent cooling of the part. Injection stretch blow molding may also benefit from the optimized thermal gradient resulting from microwave selective heating, allowing for improved mechanical properties of the final product.

In some embodiments, a layered thermoplastic sheet, containing microwave-heatable and non-microwave-heatable layers, may be selectively heated prior to thermoforming. In other embodiments, layered or co-extruded pellets of thermoplastic materials may be selectively heated prior to subsequent processing in for example, an injection molding process. These may result in accelerated cooling due to the presence of “internal heat sinks,” and hence reduced cycle time, similar to the layered sheet case described above.

In other embodiments, pulsed microwave energy may be used to create “slices,” or discrete regions, of molten polymer interspersed with layers of un-melted polymer prior to subsequent processing. This may also result in accelerated cooling and hence reduced cycle time, similar to the layered sheet case described above.

In other embodiments, selective placement of one or more microwave emitters may allow selective heating of specific areas of a sheet or other thermoplastic part prior to subsequent processing. This may be particularly useful in thermoforming processes where the sheet must be deep drawn in a particular area.

In other embodiments, a process may employ selective heating and consolidation of an absorbent core, such as that used in hygiene products which contain a bicomponent binder fiber containing a microwave sensitive component (in particular polypropylene fibers or fibers containing a microwave-heatable composition, such as a maleic-anhydride graft or other polar species) and cellulosic fibers. For example, in a fiber-forming process, the planar material may pass through a microwave heater with energy sufficient to partially melt the polymeric fibers and heat the cellulosic fibers, by virtue of their inherent moisture content. Subsequently the fibers may be consolidated into an absorbent core with in integrated network of polymeric fibers and cellulose. Alternatively, the construction may be a technical textile where the microwave sensitive fiber may be used to bind together the woven or non-woven structure as a covered yarn.

In other embodiments, microwave-heatable compositions may be used in the skin and/or core of a three (or more) layered foam structure (for example, a sheet), comprising solid skins and a foam core. The concentration of the microwave receptive additives may be varied in each of the layers and the microwave power selected in order to achieve both rapid heating of each of the layers and the desired temperature distribution through the whole structure immediately prior to subsequent processing. This may eliminate the need for the very gradual heating required in infrared heating processes to achieve the desired thermoforming temperature profile without premature foam collapse.

As described above, embodiments described herein may provide for polymer compositions and composites designed to have a selected heating rate. Such compositions and composites may provide for rapid, volumetric heating of a thermoplastic material.

Embodiments disclosed herein may be used for the selective microwave heating of thermoplastic polymer materials. With regard to polymer processing, this technology offers many advantages for designers and processors, including selective, rapid heating; reduced heating/cooling cycle times (high speed); high energy efficiency and other environmental benefits such as reduced emissions (as it is a dry and fumeless process) and increased recycling potential (through enabling the more widespread use of self-reinforced single material components); preservation of properties in self-reinforced parts (reduces risk of reversion); increased productivity; improved part quality and strength; and minimization of thermal degradation due to reduced residence time in a thermal process, and therefore thermal stabilization additives can be reduced in polymer formulation.

Advantageously, embodiments disclosed herein may provide reduced heating times, reducing overall fabrication cycle time and hence reduced piece part cost. Embodiments disclosed herein may also provide reduced cooling times as a result of the use of selective heating, introducing “heat sinks” within a material that is being processed. Additionally, volumetric heating eliminates the need for “surface” or “contact” heating and therefore eliminates the potentially deleterious effects of high polymer surface temperatures. Volumetric heating also eliminates the undesirable temperature gradient across the sheet thickness.

Embodiments disclosed herein may also advantageously provide improved productivity through reduced overall cycle times and reduced system energy requirements. Embodiments disclosed herein may also provide tailored thermal profiling providing optimum thermoforming conditions for all thermoplastic materials and, in particular, enabling the thermoforming of thick thermoplastic polyolefin sheet, which otherwise has an unacceptably narrow processing window.

In addition to advantages provided via microwave heating as compared to conventional radiant heating, compositions and composites having selected heating rates according to embodiments disclosed herein may allow for viable use of microwave-heatable materials in various processes, such as thermoforming and injection molding, for example. Composites and compositions may be designed to have a selected heating rate and to meet physical property requirements, cycle time requirements, and other needs as may be required to result in economically and industrially viable processes.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

1. A method of formulating a microwave-heatable thermoplastic composition designed to have a selected heating rate, the method comprising:
selecting at least one of a microwave receptive additive, a microwave receptive additive particle size, and a concentration of the microwave receptive additive;
selecting at least two inputs selected from the group consisting of a thermoplastic polymer composition, a microwave power, an electric field strength, a maximum allowable temperature of the thermoplastic polymer composition, a processing temperature of the thermoplastic polymer composition, and a thermal diffusivity of the thermoplastic polymer composition;
mixing a microwave receptive additive with a thermoplastic polymer to form the microwave-heatable thermoplastic composition having a selected heating rate based on the selecting at least one and the selecting at least two.

2. The method of claim 1, wherein the selected heating rate is within the range from 5° C. per second to 150° C. per second.

3. The method of claim 1, wherein the selected heating rate is selected so as to result in at least one of a minimum cycle time, a desired cycle time, an economically viable cycle time, a maximum cycle time, and a cycle time range.

4. The method of claim 1, wherein the microwave receptive additive particle size selected is within the range from 10 nanometers to 60 microns.

5. The method of claim 1, wherein the microwave receptive additive concentration selected is within the range from 0 to 25 volume percent, based on a total volume of the microwave-heatable thermoplastic composition.

6. A method of manufacturing a microwave-heatable composition designed to have a selected heating rate, the method comprising:
selecting at least two inputs selected from the group consisting of a thermoplastic polymer composition, a microwave power, an electric field strength, a maximum allowable temperature of the thermoplastic polymer composition, a processing temperature of the thermoplastic polymer composition, and a thermal diffusivity of the thermoplastic polymer composition;
selecting at least one of a microwave receptive additive, a particle size of the microwave receptive additive, and a concentration of the microwave receptive additive;
determining a heating rate of the microwave-heatable thermoplastic composition; and
varying at least one of the microwave receptive additive, the particle size of the microwave receptive additive, and the concentration of the microwave receptive additive; and
repeating the selecting, the determining a heating rate, and the varying until a selected heating rate convergence criteria is met.

7. The method of claim 6, further comprising constraining at least one of the microwave receptive additive, the particle size of the microwave receptive additive, and the concentration of the microwave receptive additive.

8. The method of claim 6, further comprising:
determining a thermal response of a microwave receptive additive when exposed to a microwave energy field.

9. The method of claim 8, further comprising:
determining a lattice constant based on the selected particle size and the selected concentration.

10. The method of claim 9, wherein the determined heating rate is a function of the determined lattice constant, the determined thermal response, and the thermal diffusivity of the thermoplastic polymer composition.

11. The method of claim 6, further comprising:
determining a maximum temperature of a microwave receptive additive based on at least one of the electric field strength, the microwave power, and the microwave frequency;
wherein the selected microwave receptive additive has a maximum temperature less than or equal to the maximum allowable temperature of the thermoplastic polymer composition.

12. The method of claim 6, further comprising determining a performance envelope for the microwave-heatable composition, and wherein the selected heating rate convergence criteria is a function of the determined performance envelope.

13. The method of claim 6, further comprising graphically displaying a result of the determining a microwave receptive additive, a microwave receptive additive particle size, and a concentration of the microwave receptive additive.

14. The method of claim 6, further comprising:
manufacturing a microwave-heatable thermoplastic composition based on a result of the selecting at least two, selecting at least one, determining, varying, and repeating.

15. The method of claim 14, further comprising:
disposing the microwave-heatable thermoplastic composition having a selected heating rate as a layer in a multi-layered composite.

16. (canceled)

17. (canceled)

18. (canceled)

19. A microwave-heatable thermoplastic composition, comprising:
a thermoplastic polymer; and
a microwave receptive additive;
wherein the microwave-heatable composition has a heating rate within a pre-defined performance envelope.

20. The composition of claim 19, wherein the pre-defined performance envelope is bounded by one or more of: an upper microwave receptive additive particle size limit; a lower microwave receptive additive particle size limit; a maximum microwave receptive additive particle temperature upon exposure to a selected electric field strength; a minimum heating rate; and a maximum heating rate.

21. The composition of claim 20, wherein the upper microwave receptive additive particle size limit is within the range from about 1 micron to about 60 microns.

22. The composition of claim 20, wherein the minimum heating rate is at least 10° C. per minute, and wherein the maximum heating rate is less than 150° C. per second.

23. (canceled)

24. (canceled)

25. The composition of claim 19, wherein the pre-defined performance envelope is based on at least one of thermoforming process economics, process cycle times, and a physical property requirement of the thermoplastic polymer.
